(19) United States
(12) Patent Application Publication
(10) Pub. No.: US 2026/0100975 A1
(43) Pub. Date: Apr. 9, 2026

(54) ANALYZING AND MANAGING RULES ASSOCIATED WITH NETWORK SECURITY POLICIES

(71) Applicant: Juniper Networks, Inc., Sunnyvale, CA (US)

(72) Inventors: Suvin P U, Bengaluru (IN); Ritesh SHELAT, Bangalore (IN); Melinda ANAND ARORA, Bangalore (IN); Yagna Siva Naga KIRAN KOTHAMASU, Bangalore (IN); Vinay Mandur SRINIVASMURTHY, Bangalore (IN); Sumanta Narayan DUTTA, Bangalore (IN)

(21) Appl. No.: 19/254,428

(22) Filed: Jun. 30, 2025

(30) Foreign Application Priority Data
Oct. 3, 2024 (IN) 202441074677

(51) Int. Cl. H04L 9/40

(52) U.S. Cl. CPC H04L 63/20

(57) ABSTRACT

A device may receive rules associated with security policies of a network with network devices, and may analyze the rules to generate a rule analysis that identifies anomalies associated with the rules and that identifies corresponding recommendations associated with correcting the anomalies. The device may display the rule analysis and the corresponding recommendations in a context of the rules and may provide an option to automatically correct the anomalies. The device may provide a preview of the corresponding recommendations within the context of the rules, and may display a view of the rules affected by the anomalies in a single view. The device may recommend rule placement while creating a new rule for the security policies.

### CROSS-REFERENCE TO RELATED APPLICATION

This Patent Application claims priority to India Provisional Patent Application No. 202441074677, filed on Oct. 3, 2024, and entitled “ANALYZING AND MANAGING RULES ASSOCIATED WITH NETWORK SECURITY POLICIES.” The disclosure of the prior Application is considered part of and is incorporated by reference into this Patent Application.

### BACKGROUND

Deploying a network security solution is essential for securing homes and businesses from cyber threats. Network devices (e.g., network firewalls) may be utilized to implement a network security solution.

### SUMMARY

Some implementations described herein relate to a method. The method may include receiving rules associated with security policies of a network with network devices. The method may include analyzing, by the device, the rules to generate a rule analysis that identifies one or more anomalies associated with the rules and that identifies one or more corresponding recommendations associated with correcting the one or more anomalies. The method may include providing for display the rule analysis and the one or more corresponding recommendations in a context of the rules.

Some implementations described herein relate to a device. The device may include one or more memories and one or more processors. The one or more processors may be configured to receive rules associated with security policies of a network with network devices, and analyze the rules to generate a rule analysis that identifies one or more anomalies associated with the rules and that identifies one or more corresponding recommendations associated with correcting the one or more anomalies. The one or more processors may be configured to provide for display the rule analysis and the one or more corresponding recommendations in a context of the rules, and provide an option to automatically correct the one or more anomalies with the one or more corresponding recommendations.

Some implementations described herein relate to a non-transitory computer-readable medium that stores a set of instructions. The set of instructions, when executed by one or more processors of a device, may cause the device to receive rules associated with security policies of a network with network devices, and analyze the rules to generate a rule analysis that identifies one or more anomalies associated with the rules and that identifies one or more corresponding recommendations associated with correcting the one or more anomalies. The set of instructions, when executed by one or more processors of the device, may cause the device to provide for display, by device, the rule analysis and the one or more corresponding recommendations in a context of the rules, and provide an option to automatically correct the one or more anomalies with the one or more corresponding recommendations.

### BRIEF DESCRIPTION OF THE DRAWINGS

FIGS. 1A-1L are diagrams of an example associated with analyzing and managing rules associated with network security policies.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for analyzing and managing rules associated with network security policies.

### DETAILED DESCRIPTION

The following detailed description of example implementations refers to the accompanying drawings. The same reference numbers in different drawings may identify the same or similar elements.

A network firewall is a network security device that monitors and filters incoming and outgoing network traffic based on an organization's established security policies and rules. A network firewall may implement security policies with rules that allow non-threatening network traffic and that reject dangerous network traffic. Network threats may change over time and the rules of the security policies may change to adapt to changing network threats. Over a period of time, network security administrators may need to manage from a few hundred to several thousands of rules. Management of a large quantity of rules becomes extremely complicated and time consuming and results in rule anomalies, such as duplicate rules, shadow rules, unused rules, and/or the like. Existing rule analysis techniques may generate a report about security policies. A network security administrator may download the report, and may review and manually correct each rule anomaly identified in the report. Such a process is time consuming and prone to errors.

Thus, current techniques for analyzing and managing rules associated with network security policies consume computing resources (e.g., processing resources, memory resources, communication resources, and/or the like), networking resources, and/or the like associated with generating a report that requires time consuming and error prone manipulation of rule anomalies, failing to address all rule anomalies associated with network security policies, generating network security policies that fail to handle network security threats, handling downtime and lost traffic caused by network security threats not addressed by network security policies, and/or the like.

Some implementations described herein relate to a management system for analyzing and managing rules associated with network security policies. For example, a management system may receive rules associated with security policies of a network with network devices, and may analyze the rules to generate a rule analysis that identifies anomalies associated with the rules and that identifies corresponding recommendations associated with correcting the anomalies. The management system may display the rule analysis and the corresponding recommendations in a context of the rules and may provide an option to automatically correct the anomalies. The management system may provide a preview of the corresponding recommendations within the context of the rules, and may display a view of the rules affected by the anomalies in a single view. The management system may recommend rule placement while creating a new rule for the security policies.

In this way, the management system may analyze and manage rules associated with network security policies. Thus, the management system may conserve computing resources, networking resources, and/or the like that would otherwise have been consumed by generating a report that requires time consuming and error prone manipulation of rule anomalies, failing to address all rule anomalies associated with network security policies, generating network security policies that fail to handle network security threats, handling downtime and lost traffic caused by network security threats not addressed by network security policies, and/or the like.

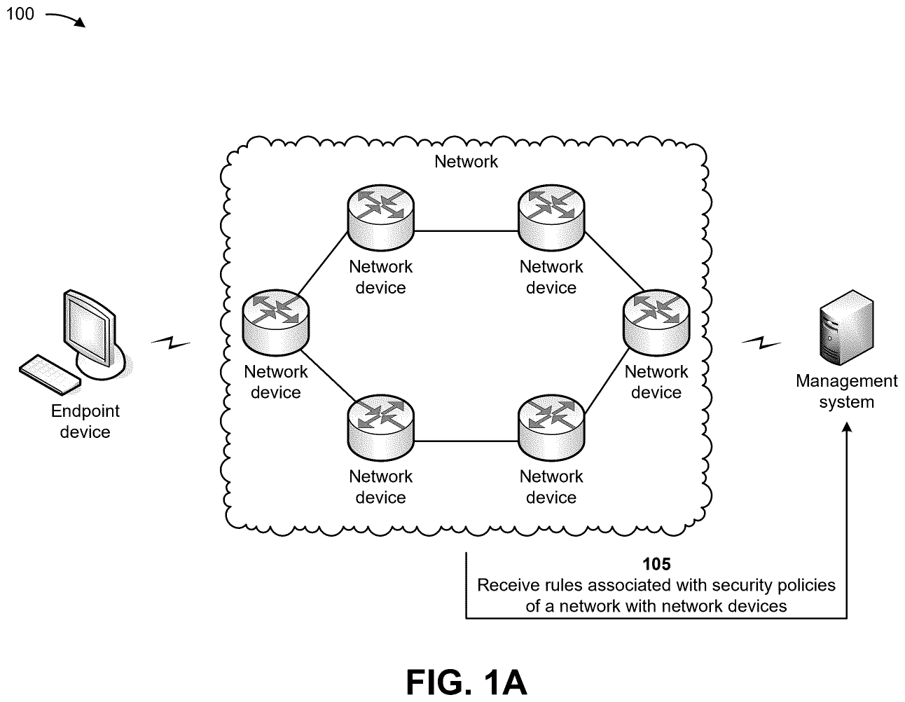

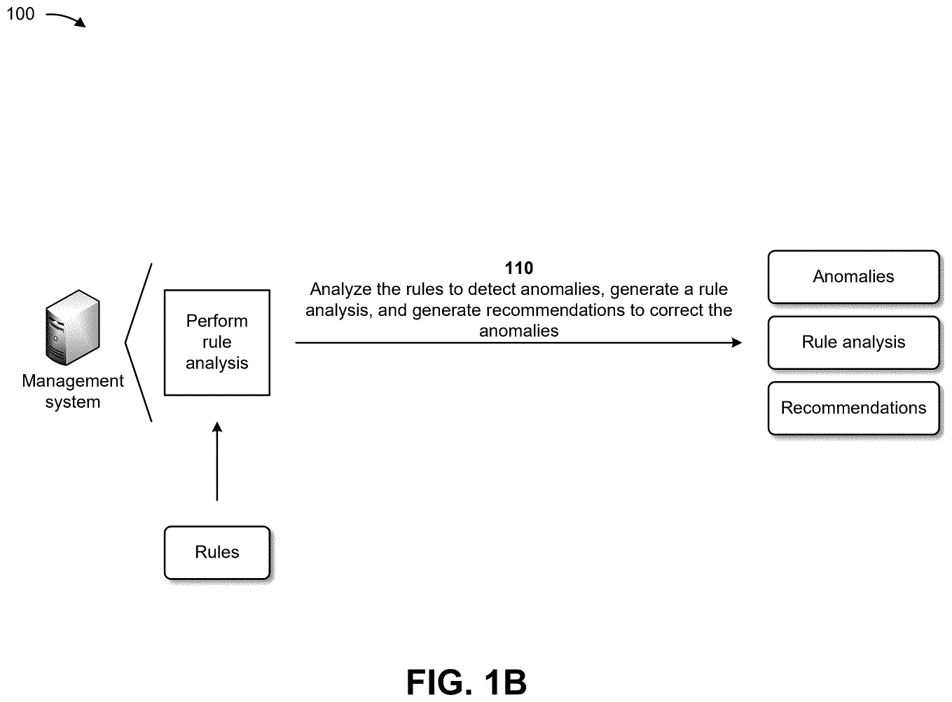

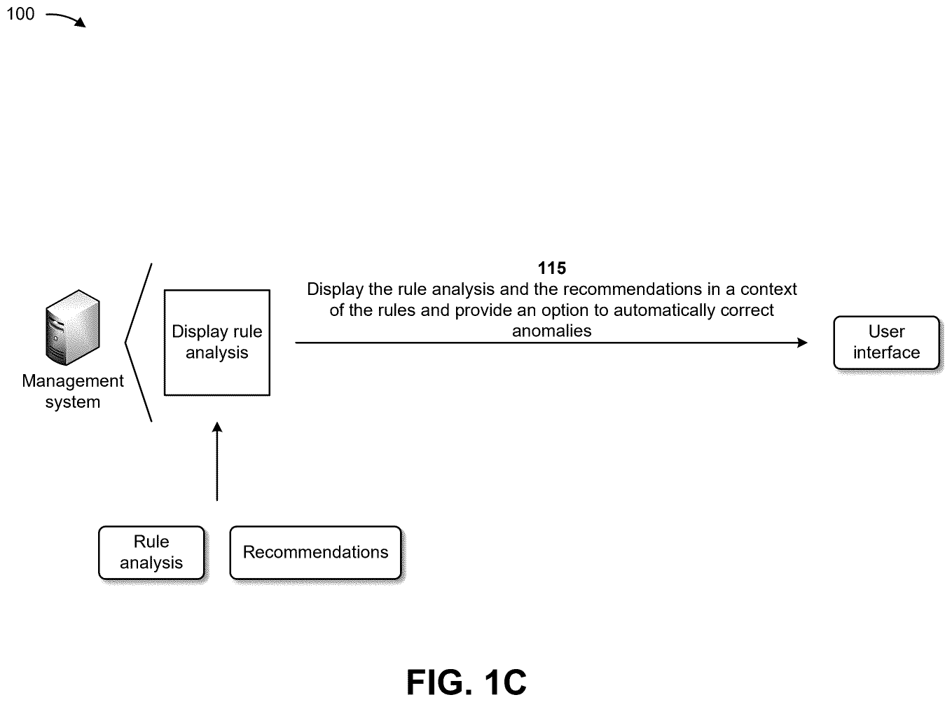

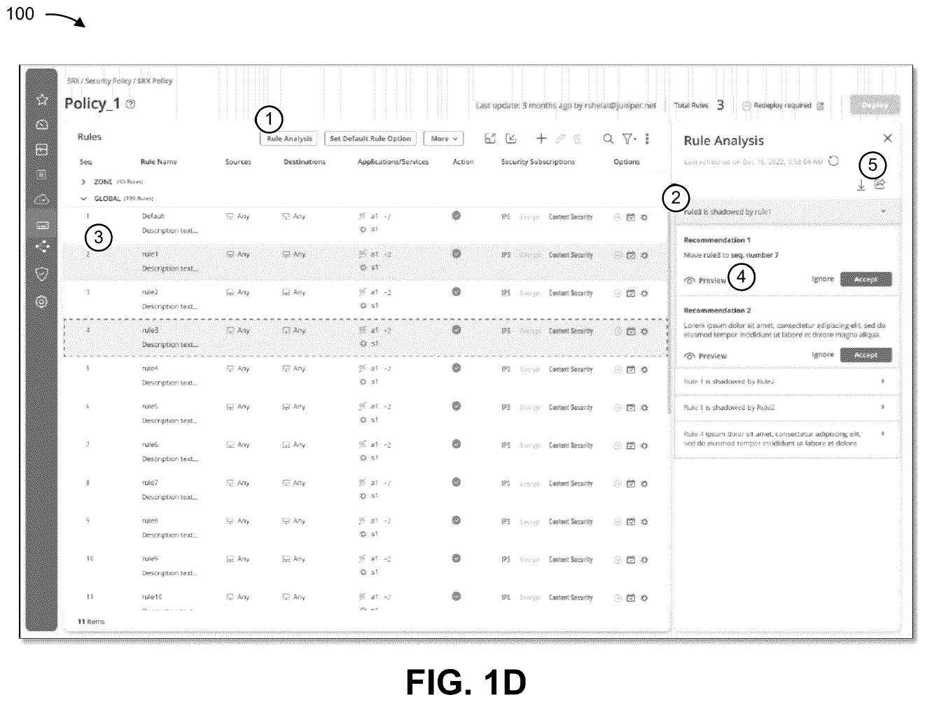

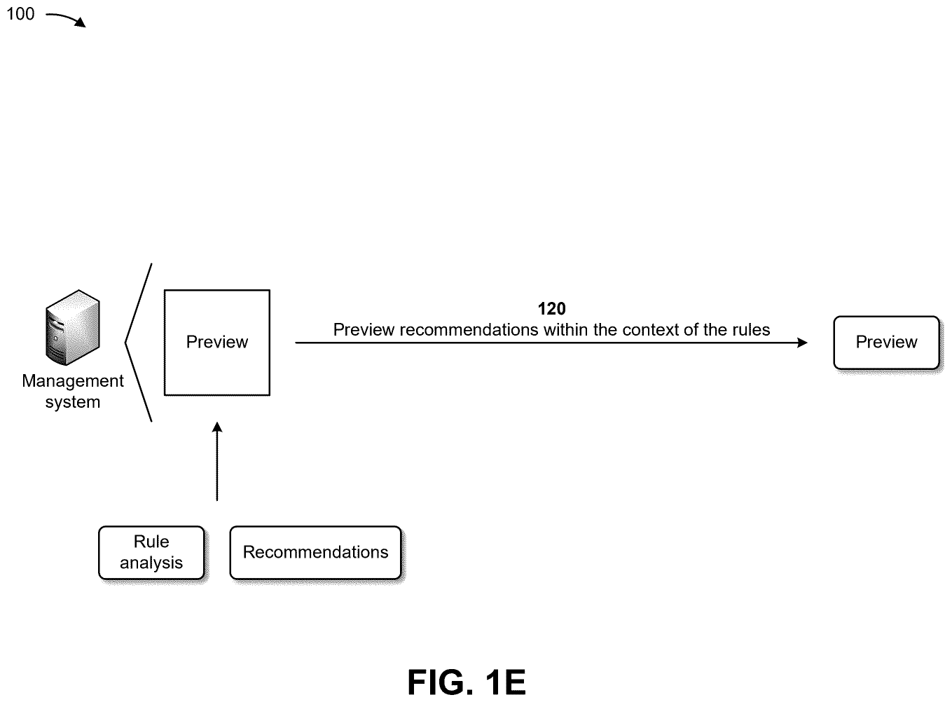

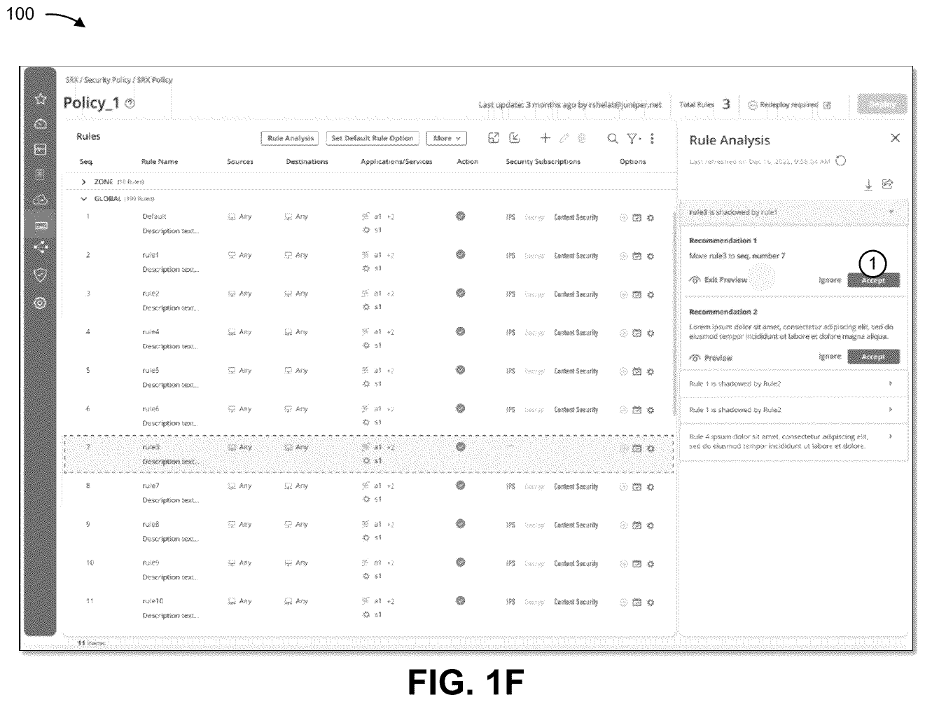

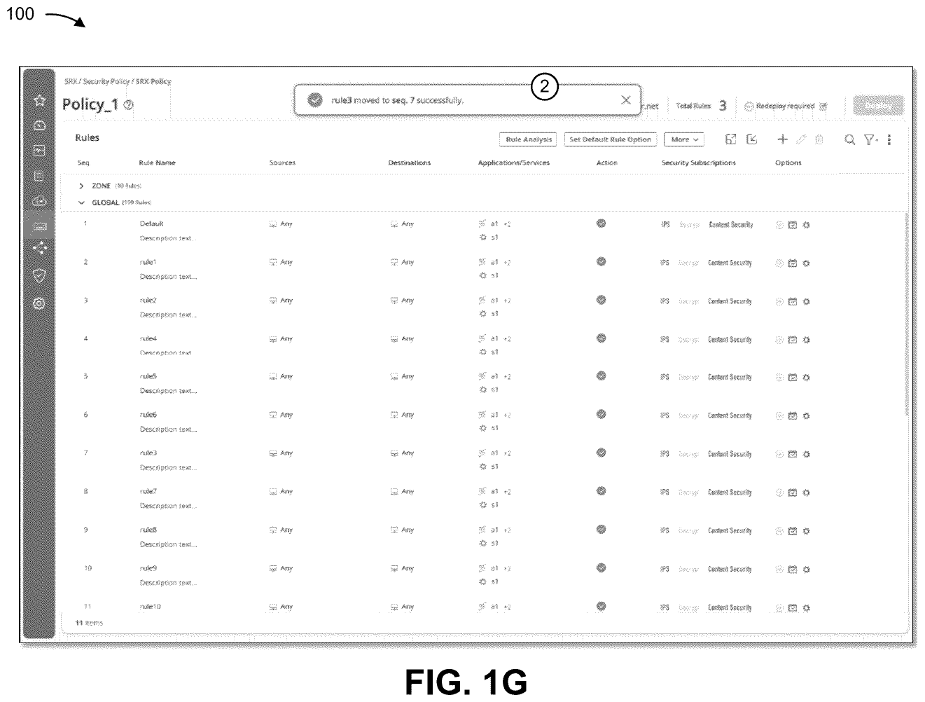

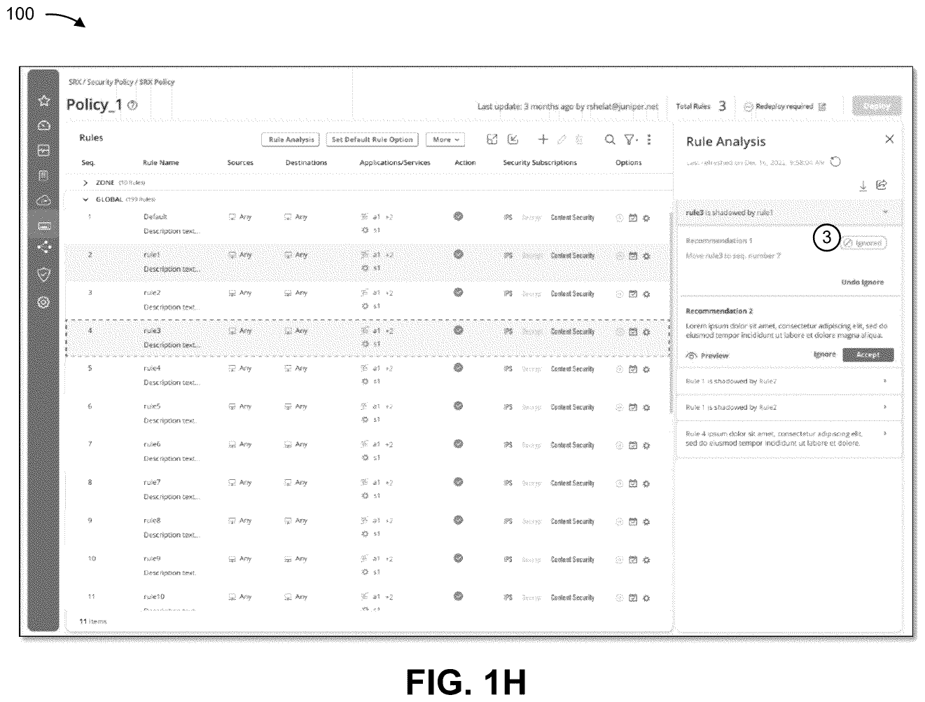

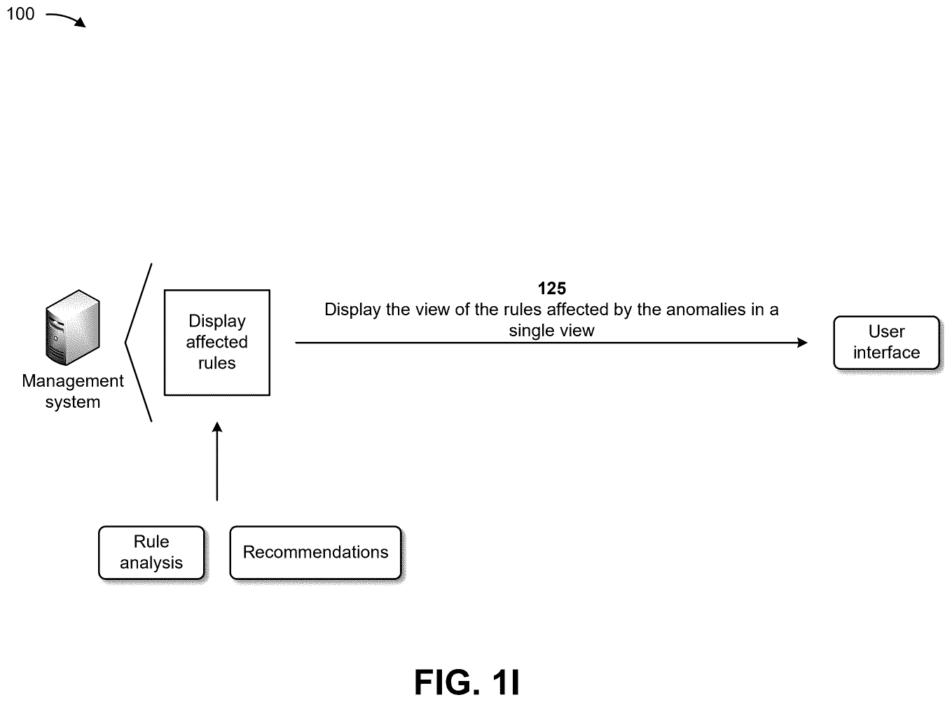

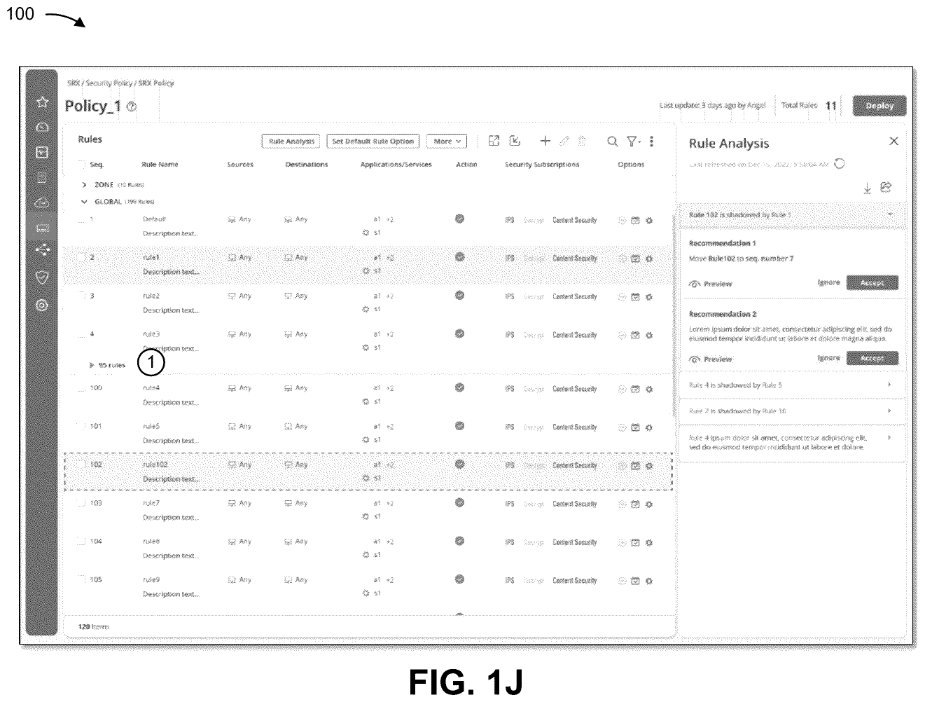

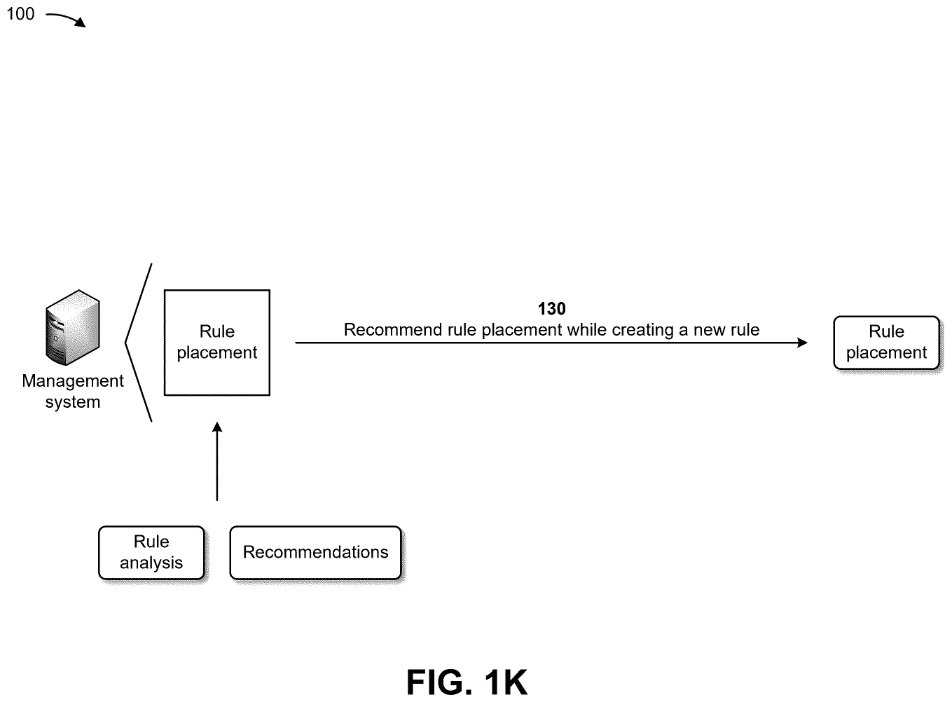

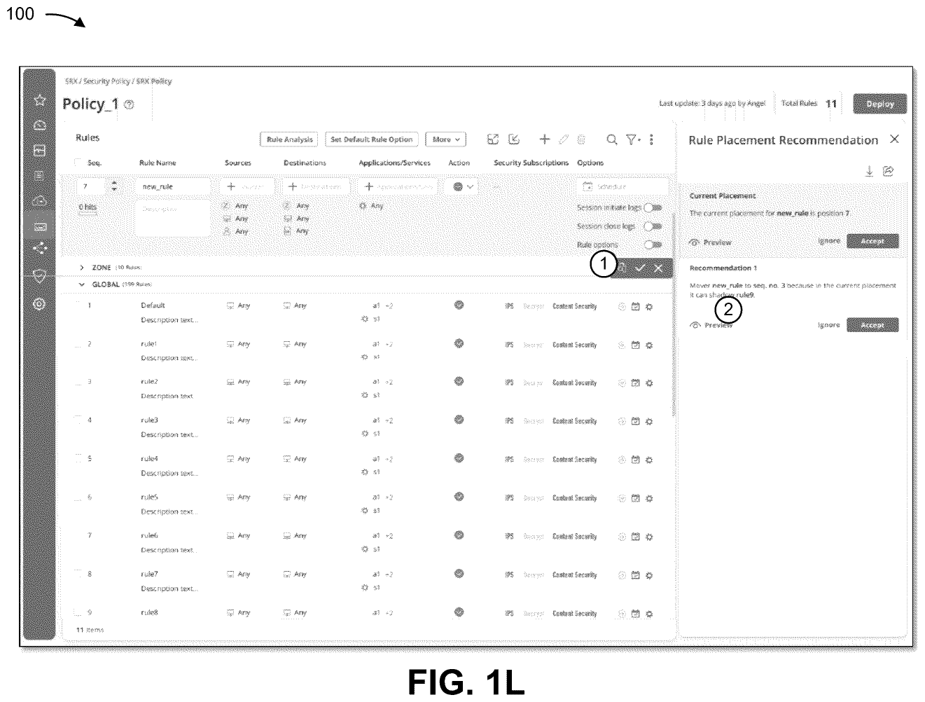

FIGS. 1A-1L are diagrams of an example 100 associated with analyzing and managing rules associated with network security policies. As shown in FIG. 1A, the example 100 includes an endpoint device associated with a management system and a network with multiple network devices. Further details of the endpoint device, the management system, the network, and the network devices are provided elsewhere herein.

As shown in FIG. 1A, and by reference number 105, the management system may receive rules associated with security policies of the network with the network devices. For example, the network devices of the network may be programmed with security policies that include rules for addressing network threats. In some implementations, the security policies may include rules that allow non-threatening network traffic, rules that reject dangerous network traffic, and/or the like. The network threats may change over time and the rules of the security policies may change to adapt to changing network threats. In some implementations, the security policies may include one or more of a user access policy, a user authentication policy, a data protection policy, a network usage policy, a network configuration policy, a device security policy, and/or the like.

The management system may continually receive the rules from the network devices, may periodically receive the rules from the network devices, may receive the rules from the network devices based on requesting the rules from the network devices, and/or the like. In some implementations, the management system may store the rules associated with the security policies in a data structure (e.g., a database, a table, a list, and/or the like) associated with the management system.

As shown in FIG. 1B, and by reference number 110, the management system may analyze the rules to detect anomalies, generate a rule analysis, and generate recommendations to correct the anomalies. For example, the management system may analyze the rules to generate a rule analysis that identifies anomalies associated with the rules and that identifies corresponding recommendations associated with correcting the anomalies. In some implementations, the anomalies associated with the rules may include duplicate rules, shadow rules (e.g., rules that will never be executed because they are preceded by a more general rule that matches the same traffic), unused rules, and/or the like. The corresponding recommendations associated with correcting the anomalies may include a recommendation to delete a duplicate rule, a recommendation to delete a shadow rule, a recommendation to delete an unused rule, a recommendation to add a new rule, a recommendation to change a location of a rule, and/or the like. In some implementations, the rule analysis may include a listing of all of the rules associated with the security policies.

In some implementations, the management system may analyze the rules to identify anomalies using a combination of rule comparison, ordering, and traffic matching techniques. For example, to detect duplicate rules, the management system may parse each rule's criteria (e.g., source and destination network addresses, ports, and protocols) and may compare the criteria for exact matches with other rules in the same security policy. To identify shadow rules, the management system may evaluate the match conditions and actions of each rule in the order in which they are processed by the network devices, determining if a preceding rule would always match the same traffic as a subsequent rule, thereby preventing the later rule from being executed. Unused rules may be identified by correlating rule match conditions with historical traffic logs or counters, flagging any rule that has not matched network traffic over a configurable time period. The management system may generate recommendations such as deleting exact duplicates, removing or reordering shadowed rules, or archiving unused rules. These analyses can be implemented by applying pattern matching, rule ordering analysis, and statistical usage evaluation algorithms, which may be configured through user-defined thresholds and parameters.

As shown in FIG. 1C, and by reference number 115, the management system may display the rule analysis and the recommendations in a context of the rules and may provide an option to automatically correct anomalies. For example, the management system may generate a user interface that includes the rule analysis, the anomalies associated with the rules, and the corresponding recommendations associated with correcting the anomalies. The management system may provide the user interface to a device (e.g., the endpoint device), and the endpoint device may display the user interface to a user (e.g., a network engineer) of the endpoint device. In some implementations, the management system may generate a report based on the rule analysis, and may provide the report to one or more network engineers (e.g., via the endpoint device).

In some implementations, with reference to FIG. 1D, a rule analysis selection mechanism (e.g., a button) may be provided in a user interface that includes the rules and the security policies. In this way, the rule analysis is within a context of the rules to be analyzed by a user of the management system. When the rule analysis button is selected (e.g., as shown at item “1” in FIG. 1D), the management system may perform the rule analysis and may display the rule analysis in a right panel, as further shown in FIG. 1D. The right panel may display a list of the anomalies along with recommendations to correct the anomalies. In some implementations, the anomalies may be listed in collapsible sections so that the user may view one anomaly at a time (e.g., as shown at item “2” of FIG. 1D). When an anomaly is selected, corresponding rules may be highlighted in a main panel of the user interface (e.g., as shown at item “3” of FIG. 1D). The user may preview a recommended solution and may implement a recommended solution with a single selection (e.g., a single click, as shown at item “4” of FIG. 1D). The user may choose to accept or ignore a recommended solution. In some implementations, the management system may enable the user to download or share the rule analysis without having to navigate to a different page to perform such tasks (e.g., as shown at item “5”of FIG. 1D).

As shown in FIG. 1E, and by reference number 120, the management system may preview the recommendations within the context of the rules. For example, the management system may generate a user interface that provides a preview of the corresponding recommendations within the context of the rules. The management system may provide the user interface with the preview to the endpoint device, and the endpoint device may display the user interface with the preview to the user of the endpoint device.

In some implementations, with reference to FIG. 1F, when the user selects a preview for a recommendation (e.g., as shown at item “1” of FIG. 1F), the management system may provide a preview of a placement of a rule as per the recommendation. For example, as shown in FIG. 1F, when the user selects “Preview” under “Recommendation 1,” the “rule 3” in the main panel may be moved to “seq. 7” and the new position may be highlighted. The user may quickly decide whether to accept or ignore the recommendation. As shown in FIG. 1G, when the user accepts the recommendation, the management system may automatically resolve the anomaly and may display a success message (e.g., as shown at item “2” in FIG. 1G). As shown at item “3” in FIG. 1H, when the user ignores the recommendation, the management system may tag the recommendation as “ignored,”but may enable the user to undo the “ignore”tag at any time.

As shown in FIG. 1I, and by reference number 125, the management system may display a view of the rules affected by the anomalies in a single view. For example, the management system may generate a user interface that provides a view of the rules affected by the anomalies in a single view. The management system may provide the user interface with the view to the endpoint device, and the endpoint device may display the user interface with the view to the user of the endpoint device.

In some implementations, with reference to FIG. 1J, while the anomalies are reported, the affected rules may be spread across several pages in the main panel. The management system may display all of the rules together in the main panel without requiring the user to scroll, which may facilitate quicker decision-making by the user. The management system may achieve this by collapsing intermediate rules between the affected rules (e.g., as shown at item “1” in FIG. 1J) so that an affected rule can be shown in a same view as a rule by which it is affected. This may enable the user to view the affected rules together (e.g., without a need to scroll). For example, the user may view “rule 1” and “rule 102” together in a single view since the rules between these rules are collapsed. The management system may also enable the user to expand the collapsed rules at any time.

As shown in FIG. 1K, and by reference number 130, the management system may recommend rule placement while creating a new rule. For example, the management system may receive (e.g., from the endpoint device) or generate a new rule for the security policies based on the rule analysis and the corresponding recommendations. The management system may generate a recommended rule placement of the new rule with respect to the rules associated with the security policies, and may provide the new rule and the recommended rule placement in a user interface. The management system may provide the user interface with the new rule and the recommended rule placement to the endpoint device, and the endpoint device may display the user interface with the new rule and the recommended rule placement to the user of the endpoint device. In some implementations, the management system may receive (e.g., from the endpoint device) an acceptance of the recommended rule placement of the new rule, and may utilize the recommended rule placement of the new rule based on the acceptance.

In some implementations, with reference to FIG. 1L, while creating a new rule, the user may select a “recommend rule placement” icon (e.g., as shown at item “1”of FIG. 1L). Upon selection of the icon, the management system may place the new rule in an appropriate placement and may display the recommended rule placement to the user in the main panel (e.g., shown at item “2” of FIG. 1L). The user may preview the recommended rule placement, and may accept or ignore the recommended rule placement. In this way, the user may prevent new anomalies, associated with the new rule, from being generated.

In this way, the management system may analyze and manage rules associated with network security policies. Thus, the management system may conserve computing resources, networking resources, and/or the like that would otherwise have been consumed by generating a report that requires time consuming and error prone manipulation of rule anomalies, failing to address all rule anomalies associated with network security policies, generating network security policies that fail to handle network security threats, handling downtime and lost traffic caused by network security threats not addressed by network security policies, and/or the like.

As indicated above, FIGS. 1A-1L are provided as an example. Other examples may differ from what is described with regard to FIGS. 1A-1L. The number and arrangement of devices shown in FIGS. 1A-1L are provided as an example. In practice, there may be additional devices, fewer devices, different devices, or differently arranged devices than those shown in FIGS. 1A-1L. Furthermore, two or more devices shown in FIGS. 1A-1L may be implemented within a single device, or a single device shown in FIGS. 1A-1L may be implemented as multiple, distributed devices. Additionally, or alternatively, a set of devices (e.g., one or more devices) shown in FIGS. 1A-1L may perform one or more functions described as being performed by another set of devices shown in FIGS. 1A-1L.

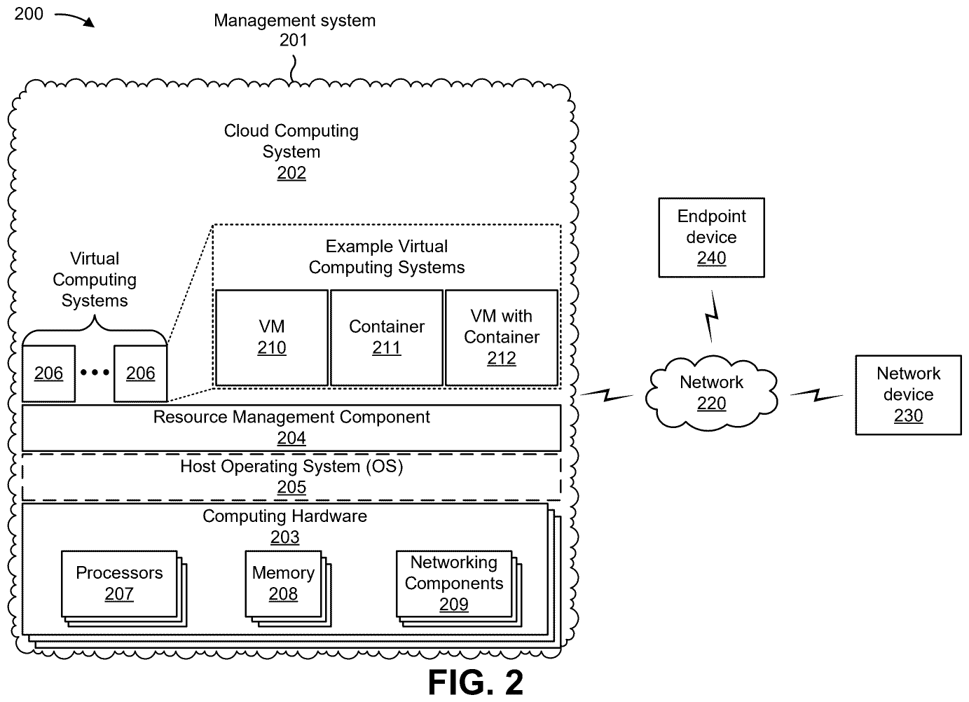

FIG. 2 is a diagram of an example environment 200 in which systems and/or methods described herein may be implemented. As shown in FIG. 2, the environment 200 may include a management system 201, which may include one or more elements of and/or may execute within a cloud computing system 202. The cloud computing system 202 may include one or more elements 203-212, as described in more detail below. As further shown in FIG. 2, the environment 200 may include a network 220, a network device 230, and/or an endpoint device 240. Devices and/or elements of the environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as the computing hardware 203) capable of virtualizing the computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using the computing hardware 203. As shown, the virtual computing system 206 may include a virtual machine 210, a container 211, or a hybrid environment 212 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

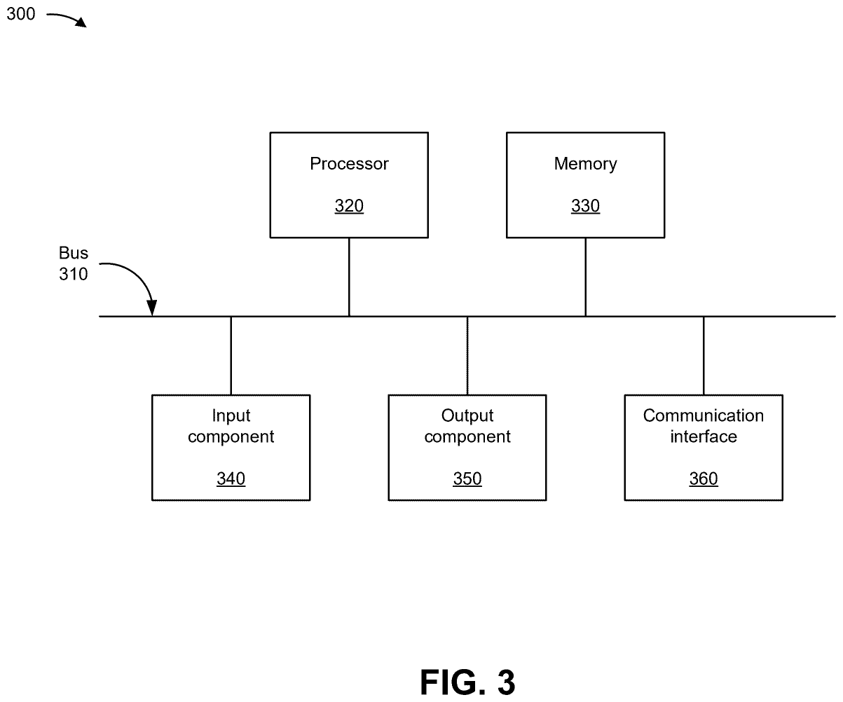

Although the management system 201 may include one or more elements 203-212 of the cloud computing system 202, may execute within the cloud computing system 202, and/or may be hosted within the cloud computing system 202, in some implementations, the management system 201 may not be cloud-based (e.g., may be implemented outside of a cloud computing system) or may be partially cloud-based. For example, the management system 201 may include one or more devices that are not part of the cloud computing system 202, such as a device 300 of FIG. 3, which may include a standalone server or another type of computing device. The management system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The network device 230 may include one or more devices capable of receiving, processing, storing, routing, and/or providing traffic (e.g., a packet and/or other information or metadata) in a manner described herein. For example, the network device 230 may include a router, such as a label switching router (LSR), a label edge router (LER), an ingress router, an egress router, a provider router (e.g., a provider edge router or a provider core router), a virtual router, or another type of router. Additionally, or alternatively, the network device 230 may include a gateway, a switch, a firewall, a hub, a bridge, a reverse proxy, a server (e.g., a proxy server, a cloud server, or a data center server), a load balancer, and/or a similar device. In some implementations, the network device 230 may be a physical device implemented within a housing, such as a chassis. In some implementations, the network device 230 may be a virtual device implemented by one or more computing devices of a cloud computing environment or a data center. In some implementations, a group of network devices 230 may be a group of data center nodes that are used to route traffic flow through a network.

The endpoint device 240 may include one or more devices capable of receiving, generating, storing, processing, and/or providing information, as described elsewhere herein. The endpoint device 240 may include a communication device and/or a computing device. For example, the endpoint device 240 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of one or more devices of FIG. 2. The example components may be included in a device 300, which may correspond to the management system 201, the network device 230, and/or the endpoint device 240. In some implementations, the management system 201, the network device 230, and/or the endpoint device 240 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

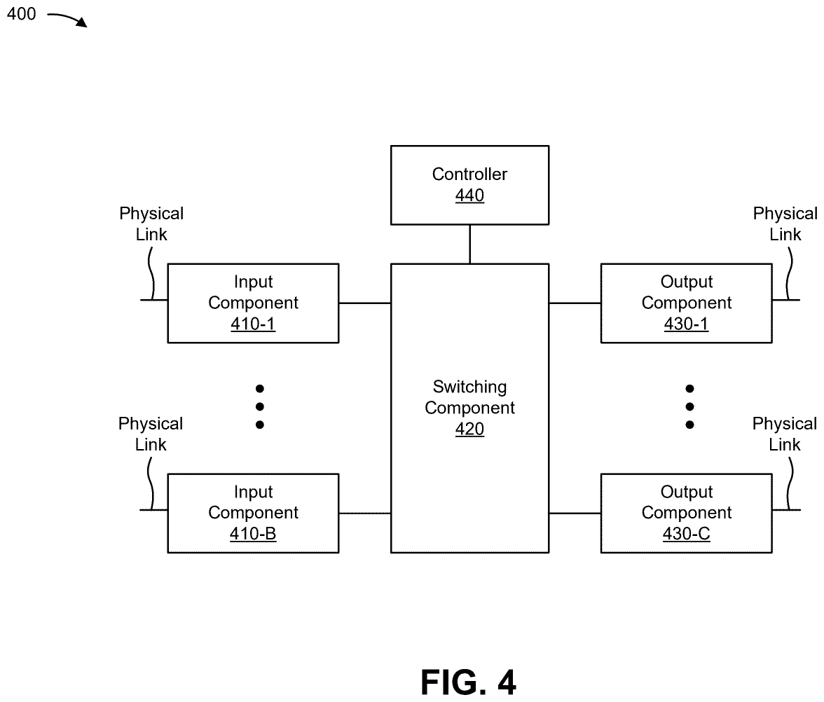

FIG. 4 is a diagram of example components of one or more devices of FIG. 2. The example components may be included in a device 400. The device 400 may correspond to the network device 230. In some implementations, the network device 230 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

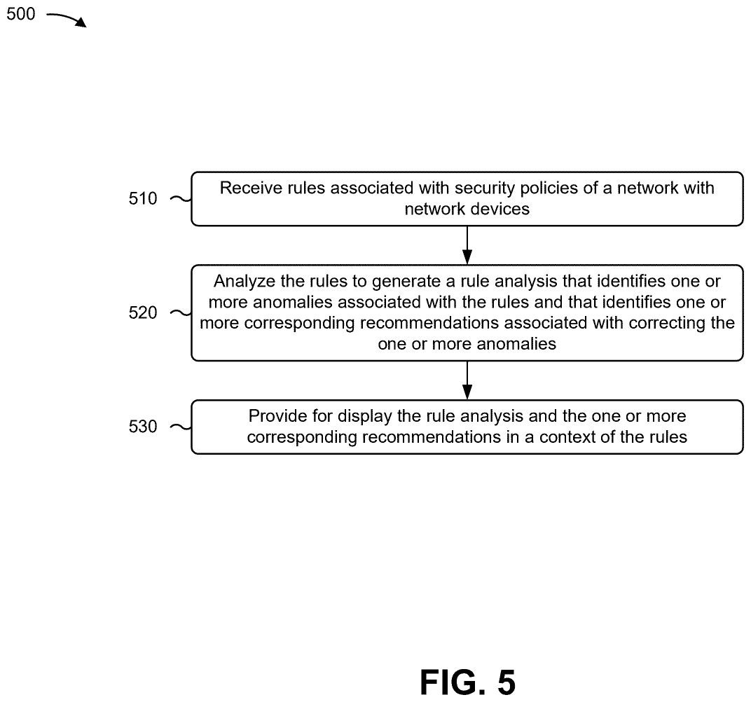

FIG. 5 is a flowchart of an example process 500 for analyzing and managing rules associated with network security policies. In some implementations, one or more process blocks of FIG. 5 may be performed by a device (e.g., the management system 201). In some implementations, one or more process blocks of FIG. 5 may be performed by another device or a group of devices separate from or including the device, such as an endpoint device (e.g., the endpoint device 240) and/or a network device (e.g., the network device 230). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving rules associated with security policies of a network with network devices (block 510). For example, the device may receive rules associated with security policies of a network with network devices, as described above. In some implementations, the security policies include one or more of a user access policy, a user authentication policy, a data protection policy, a network usage policy, a network configuration policy, or a device security policy.

As further shown in FIG. 5, process 500 may include analyzing the rules to generate a rule analysis that identifies one or more anomalies associated with the rules and that identifies one or more corresponding recommendations associated with correcting the one or more anomalies (block 520). For example, the device may analyze the rules to generate a rule analysis that identifies one or more anomalies associated with the rules and that identifies one or more corresponding recommendations associated with correcting the one or more anomalies, as described above.

As further shown in FIG. 5, process 500 may include providing for display the rule analysis and the one or more corresponding recommendations in a context of the rules (block 530). For example, the device may provide for display the rule analysis and the one or more corresponding recommendations in a context of the rules, as described above. In some implementations, providing for display the rule analysis and the one or more corresponding recommendations includes providing the one or more anomalies for display as one or more corresponding collapsible sections.

In some implementations, process 500 includes providing an option to automatically correct the one or more anomalies with the one or more corresponding recommendations. In some implementations, process 500 includes providing a preview of the one or more corresponding recommendations within the context of the rules. In some implementations, providing the preview of the one or more corresponding recommendations includes providing a preview of placement of one of the rules based on the one or more corresponding recommendations.

In some implementations, process 500 includes receiving an indication of acceptance of the placement of the one of the rules, and correcting one of the one or more anomalies based on the indication. In some implementations, process 500 includes receiving an indication of rejection of the placement of the one of the rules, and tagging one of the one or more corresponding recommendations as ignored based on the indication. In some implementations, process 500 includes displaying a view of the rules affected by the one or more anomalies in a single view. In some implementations, displaying the view of the rules affected by the one or more anomalies in the single view includes collapsing rules provided between the rules affected by the one or more anomalies.

In some implementations, process 500 includes receiving a new rule for the security policies, and providing a recommended placement of the new rule with respect to the rules associated with the security policies. In some implementations, process 500 includes receiving an acceptance of the recommended placement of the new rule, and utilizing the recommended placement of the new rule based on the acceptance. In some implementations, process 500 includes generating a report based on the rule analysis, and providing the report to one or more network engineers.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, rules associated with security policies of a network with network devices;
analyzing, by the device, the rules to generate a rule analysis that identifies one or more anomalies associated with the rules and that identifies one or more corresponding recommendations associated with correcting the one or more anomalies; and
providing for display, by device, the rule analysis and the one or more corresponding recommendations in a context of the rules.

2. The method of claim 1, wherein providing for display the rule analysis and the one or more corresponding recommendations comprises:
providing the one or more anomalies for display as one or more corresponding collapsible sections.

3. The method of claim 1, further comprising:
providing an option to automatically correct the one or more anomalies with the one or more corresponding recommendations.

4. The method of claim 1, further comprising:
providing a preview of the one or more corresponding recommendations within the context of the rules.

5. The method of claim 4, wherein providing the preview of the one or more corresponding recommendations comprises:
providing a preview of placement of one of the rules based on the one or more corresponding recommendations.

6. The method of claim 5, further comprising:
receiving an indication of acceptance of the placement of the one of the rules; and
correcting one of the one or more anomalies based on the indication.

7. The method of claim 5, further comprising:
receiving an indication of rejection of the placement of the one of the rules; and
tagging one of the one or more corresponding recommendations as ignored based on the indication.

8. A device, comprising:
one or more memories; and
one or more processors to:
receive rules associated with security policies of a network with network devices;
analyze the rules to generate a rule analysis that identifies one or more anomalies associated with the rules and that identifies one or more corresponding recommendations associated with correcting the one or more anomalies;
provide for display, by device, the rule analysis and the one or more corresponding recommendations in a context of the rules; and
provide an option to automatically correct the one or more anomalies with the one or more corresponding recommendations.

9. The device of claim 8, wherein the one or more processors are further to:
display a view of the rules affected by the one or more anomalies in a single view.

10. The device of claim 9, wherein the one or more processors, to display the view of the rules affected by the one or more anomalies in the single view, are to:
collapse rules provided between the rules affected by the one or more anomalies.

11. The device of claim 8, wherein the one or more processors are further to:
receive a new rule for the security policies; and
provide a recommended placement of the new rule with respect to the rules associated with the security policies.

12. The device of claim 11, wherein the one or more processors are further to:
receive an acceptance of the recommended placement of the new rule; and
utilize the recommended placement of the new rule based on the acceptance.

13. The device of claim 8, wherein the one or more processors are further to:
generate a report based on the rule analysis; and
provide the report to one or more network engineers.

14. The device of claim 8, wherein the security policies include one or more of a user access policy, a user authentication policy, a data protection policy, a network usage policy, a network configuration policy, or a device security policy.

15. A non-transitory computer-readable medium storing a set of instructions, the set of instructions comprising:
one or more instructions that, when executed by one or more processors of a device, cause the device to:
receive rules associated with security policies of a network with network devices;
analyze the rules to generate a rule analysis that identifies one or more anomalies associated with the rules and that identifies one or more corresponding recommendations associated with correcting the one or more anomalies;
provide for display, by device, the rule analysis and the one or more corresponding recommendations in a context of the rules; and
provide an option to automatically correct the one or more anomalies with the one or more corresponding recommendations.

16. The non-transitory computer-readable medium of claim 15, wherein the one or more instructions further cause the device to:
provide a preview of placement of one of the rules based on the one or more corresponding recommendations.

17. The non-transitory computer-readable medium of claim 16, wherein the one or more instructions further cause the device to:
receive an indication of acceptance of the placement of the one of the rules; and
correct one of the one or more anomalies based on the indication.

18. The non-transitory computer-readable medium of claim 16, wherein the one or more instructions further cause the device to:
receive an indication of rejection of the placement of the one of the rules; and
tag one of the one or more corresponding recommendations as ignored based on the indication.

19. The non-transitory computer-readable medium of claim 15, wherein the one or more instructions further cause the device to:
display a view of the rules affected by the one or more anomalies in a single view.

20. The non-transitory computer-readable medium of claim 15, wherein the one or more instructions further cause the device to:
receive a new rule for the security policies; and
provide a recommended placement of the new rule with respect to the rules associated with the security policies.
